(19) United States
(12) Patent Application Publication
(10) Pub. No.: US 2023/0318347 A1
(43) Pub. Date: Oct. 5, 2023

(54) ENGINE-DRIVEN GENERATOR

(71) Applicant: HONDA MOTOR CO., LTD., Tokyo (JP)

(72) Inventors: Takashi Hashizume, Wako-shi (JP); Ryuichi Kimata, Tokyo (JP)

(73) Assignee: HONDA MOTOR CO., LTD., Tokyo (JP)

(21) Appl. No.: 18/206,754

(22) Filed: Jun. 7, 2023

Related U.S. Application Data
(63) Continuation of application No. PCT/JP2021/000622, filed on Jan. 12, 2021.

(51) Int. Cl. H02J 7/14; H02J 7/00

(52) U.S. Cl. CPC H02J 7/1423; H02J 7/1415; H02J 7/0048; H02J 7/00712; H02J 2207/20

(57) ABSTRACT

An engine-driven generator comprises an engine, a generator, a first conversion circuit, a first battery, a second conversion circuit, a third conversion circuit, and a second battery. The first conversion circuit converts power generated by the generator to generate a second charging voltage and charges the first battery with the second charging voltage during an operation period in which the engine is operating. The second conversion circuit converts power supplied from the first battery, and supplies the converted power to a load. The third conversion circuit converts a DC voltage supplied from the second battery into a third charging voltage for charging the first battery and charges the first battery with the third charging voltage during a stop period in which the engine is stopped.

### CROSS-REFERENCE TO RELATED APPLICATION(S)

This application is a continuation of International Patent Application No. PCT/JP2021/000622 filed on Jan. 12, 2021, the entire disclosures of which is incorporated herein by reference.

### BACKGROUND OF THE INVENTION

### Field of the Invention

The present invention relates to an engine-driven generator.

### Description of the Related Art

An engine-driven generator (engine generator) is portable and widely used for leisure and as an emergency power supply. U.S. patent Ser. No. 10/418,924 proposes an engine-driven generator including one battery.

In the invention of U.S. patent Ser. No. 10/418,924, an engine can be started by driving a power generation unit with a battery. That is, the power generation unit functions as a starter generator. Meanwhile, since the power generation unit cannot supply power to a load when the engine is stopped, it would be convenient to supply power from the battery to the load. By the way, there are various types of batteries. A battery that can be rapidly charged is expensive, whereas a battery that cannot be rapidly charged is inexpensive. Increasing a capacity of an expensive battery significantly increases a manufacturing cost of an engine-driven generator. Meanwhile, it is easy to increase a capacity of an inexpensive battery, but the inexpensive battery cannot follow a sudden change in load in some cases.

### SUMMARY OF THE INVENTION

One aspect of the disclosure provides an engine-driven generator comprising: an engine; a generator configured to be driven by the engine; a first conversion circuit configured to convert an alternating current generated by the generator into a direct current; a first battery configured to be charged with power output from the first conversion circuit; a second conversion circuit connected to the first battery and configured to convert power supplied from the first battery, and to supply the converted power to a load; a third conversion circuit connected to the first battery and configured to convert a DC voltage supplied from the first battery into a first charging voltage; and a second battery connected to the third conversion circuit and configured to be charged with the first charging voltage supplied from the third conversion circuit, wherein the first conversion circuit is configured to convert power generated by the generator to generate a second charging voltage and to charge the first battery with the second charging voltage during an operation period in which the engine is operating, and the third conversion circuit is configured to convert a DC voltage supplied from the second battery into a third charging voltage for charging the first battery and to charge the first battery with the third charging voltage during a stop period in which the engine is stopped.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a diagram for describing an engine-driven generator;

FIG. 2 is a diagram illustrating functions implemented by a CPU; and

FIG. 3 is a flowchart illustrating a method for controlling the engine-driven generator.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

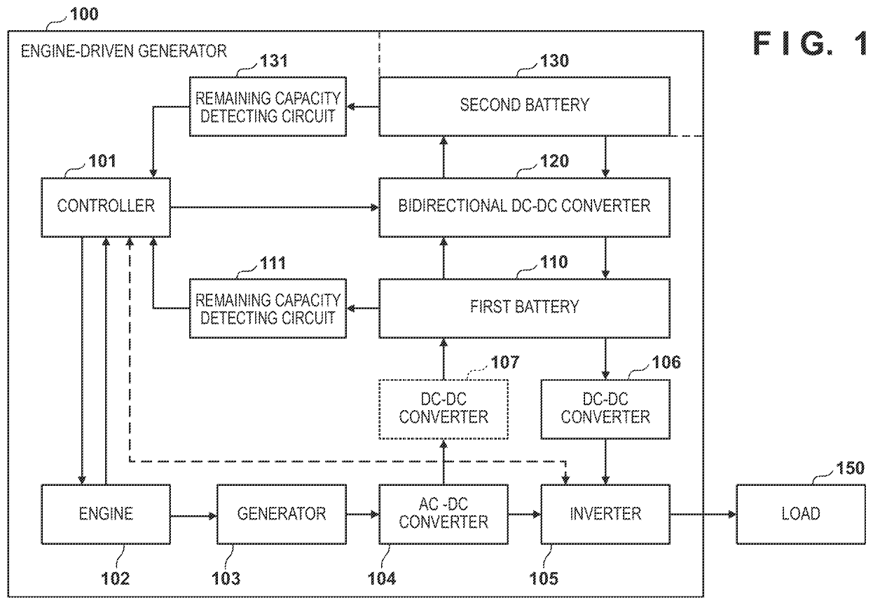

In an engine-driven generator 100 illustrated in FIG. 1, a controller 101 controls a rotation speed of an engine 102 according to a load 150. The engine 102 burns fuel (for example, gasoline, natural gas, or hydrogen) in a cylinder. A crankshaft (output shaft) that rotates in synchronization with a piston that reciprocates in the cylinder rotates. A rotor of a generator 103 is connected to the crankshaft. By rotation of the rotor, the generator 103 generates power. A stator of the generator 103 has a U winding, a V winding, and a W winding. The U winding, the V winding, and the W winding are connected to an AC-DC converter 104. The AC-DC converter 104 is a conversion circuit that converts an alternating current generated by the generator 103 into a direct current. The AC-DC converter 104 rectifies an alternating current generated in the U winding, the V winding, and the W winding to generate a pulsating flow, and smooths the pulsating flow to generate a direct current. Here, the smoothed DC voltage may be referred to as a DC link voltage. The DC voltage output from the AC-DC converter 104 is supplied to a first battery 110 as a charging voltage for charging the first battery 110. An inverter 105 converts the DC voltage (DC link voltage) supplied from the first battery 110 into an AC voltage and supplies the AC voltage to the load 150.

The inverter 105 may include a current detection circuit that detects a load current supplied to the load 150. The controller 101 may adjust the rotation speed of the engine 102 by controlling a throttle opening of the engine 102 according to a load current notification of which is given by the inverter 105.

The engine-driven generator 100 can include two or more batteries of different types or can be connected to two or more batteries of different types. As described above, the engine-driven generator 100 can include a plurality of batteries, and therefore can achieve an increase in battery capacity. The first battery 110 is, for example, a battery fixedly attached inside the engine-driven generator 100. In FIG. 1, a second battery 130 is surrounded by a broken line. This indicates that the second battery 130 is a replaceable battery that is detachably attached to the engine-driven generator 100. Quick charging performance of the first battery 110 is higher than quick charging performance of the second battery 130. Therefore, a price of the first battery 110 is higher than a price of the second battery 130. A capacity (storage capacity) of the second battery 130 is larger than a capacity of the first battery 110. Discharge performance of the first battery 110 is higher than discharge performance of the second battery 130. Here, the discharge performance indicates a difference between a ten hour rate capacity and a one hour rate capacity. For example, it is known that a one hour rate capacity of a lead battery is smaller than a ten hour rate capacity thereof. Meanwhile, a difference between a one hour rate capacity and a ten hour rate capacity of a lithium ion battery is small.

During Engine Operation

During an operation period in which the engine 102 is operating (rotating), the AC-DC converter 104 converts power generated by the generator 103 and supplies the converted power to the first battery 110. As a result, the first battery 110 is charged. A DC-DC converter 106 is a circuit that converts (for example, boosts) a voltage supplied from the first battery 110 into an input voltage required for the inverter 105. The inverter 105 converts power supplied from the first battery 110 via the DC-DC converter 106 and supplies the converted power to the load 150. Note that when the first battery 110 is in a fully charged state during an operation period of the engine 102, the inverter 105 may convert a DC voltage supplied from the AC-DC converter 104 into an AC voltage.

Alternatively, the AC-DC converter 104 may supply a second DC voltage to the inverter 105 while supplying a first DC voltage to the first battery 110 (usually, the second DC voltage is higher than the first DC voltage). That is, to the inverter 105, a DC voltage is supplied from both or either of the first battery 110 and the AC-DC converter 104, and the inverter 105 generates an AC voltage. The AC-DC converter 104 converts power generated by the generator 103, and therefore cannot follow a rapid increase in the load 150 in some cases. In such a case, since power is supplied from the first battery 110 to the inverter 105 via the DC-DC converter 106, the inverter 105 can follow a rapid increase in the load 150. The AC-DC converter 104 may be able to generate the first DC voltage and the second DC voltage, or may generate only the second DC voltage. In this case, a DC-DC converter 107 for converting (for example, stepping-down) the second DC voltage into the first DC voltage may be connected between the AC-DC converter 104 and the first battery 110. For example, the first DC voltage may be tens of volts, and the second DC voltage may be hundreds of volts.

When the first battery 110 is in a fully charged state, a bidirectional DC-DC converter 120 converts a DC voltage supplied from the first battery 110 to generate a charging voltage, and supplies the charging voltage to the second battery 130 to charge the second battery 130. Note that when the first battery 110 is in a fully charged state and the second battery 130 is also in a fully charged state, the first battery 110 and the second battery 130 are not charged.

As described above, when the load 150 rapidly increases, it is necessary to increase a rotation speed of the engine 102 to increase a power generation amount of the generator 103. In order to increase the rotation speed of the engine 102 to a rotation speed corresponding to an increase amount of the load 150, a certain time is required. If power is directly supplied only from the AC-DC converter 104 to the inverter 105, it may be impossible to sufficiently follow the load 150 with power generation capacity of the engine 102 and the generator 103. In the present embodiment, the first battery 110 is interposed between the AC-DC converter 104 and the inverter 105. That is, since the first battery 110 supplies power to the inverter 105, it is easy to follow a rapid increase in the load 150.

During Engine Stop

During a stop period in which the engine 102 is stopped, the inverter 105 may convert power supplied from the first battery 110 and supply the converted power to the load. When a remaining capacity of the first battery 110 detected by a remaining capacity detecting circuit 111 is sufficient, the controller 101 causes the first battery 110 to supply power to the inverter 105. When the remaining capacity of the first battery 110 is not sufficient, the controller 101 may control the bidirectional DC-DC converter 120 to convert a DC voltage supplied from the second battery 130 into a charging voltage for charging the first battery 110, and charge the first battery 110. Note that only when the remaining capacity of the second battery 130 is detected by a remaining capacity detecting circuit 131 and the remaining capacity of the second battery 130 is not insufficient, the controller 101 may charge the first battery 110 with the second battery 130.

The remaining capacity detecting circuit 111 is a circuit that detects an inter-terminal voltage of the first battery 110, and for example, may divide the inter-terminal voltage and convert the divided voltage into a voltage that can be input to an analog-to-digital conversion port of the controller 101. The inter-terminal voltage of the first battery 110 correlates with the remaining capacity of the first battery 110. Therefore, the controller 101 can recognize the remaining capacity of the first battery 110 on the basis of the inter-terminal voltage of the first battery 110.

The remaining capacity detecting circuit 131 is a circuit that detects an inter-terminal voltage of the second battery 130, and for example, may divide the inter-terminal voltage and convert the divided voltage into a voltage that can be input to an analog-to-digital conversion port of the controller 101. The inter-terminal voltage of the second battery 130 correlates with the remaining capacity of the second battery 130. Therefore, the controller 101 can recognize the remaining capacity of the second battery 130 on the basis of the inter-terminal voltage of second battery 130.

Configuration of Controller

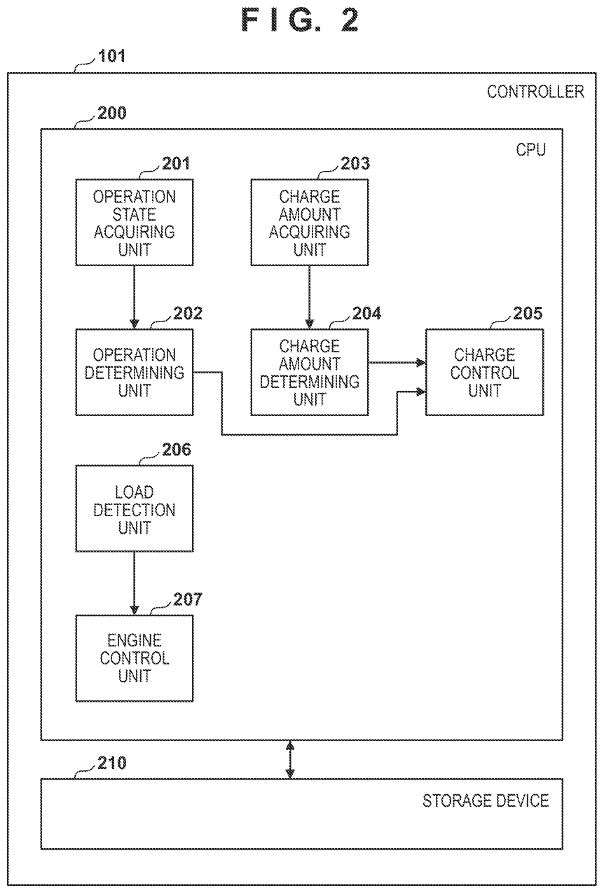

FIG. 2 illustrates a configuration of the controller 101. The controller 101 includes a CPU 200 and a storage device 210. By executing a control program stored in a read only memory (ROM) area of the storage device 210, the CPU 200 implements various functions. The storage device 210 includes a random access memory (RAM) area used for arithmetic processing of the CPU 200.

An operation state acquiring unit 201 acquires an operation state from the engine 102. For example, the operation state acquiring unit 201 acquires a pulse signal synchronized with a rotation speed output from the engine 102 when the engine 102 is rotating, and outputs the pulse signal to an operation determining unit 202. The operation determining unit 202 determines whether the engine 102 is in operation or stopped on the basis of an engine speed.

A charge amount acquiring unit 203 acquires a charge amount of the first battery 110 and a charge amount of the second battery 130. For example, the charge amount acquiring unit 203 acquires an inter-terminal voltage correlated with the charge amount of the first battery 110 from the remaining capacity detecting circuit 111. The charge amount acquiring unit 203 acquires an inter-terminal voltage correlated with the charge amount of the second battery 130 from the remaining capacity detecting circuit 131.

On the basis of the charge amount of the first battery 110 acquired by the charge amount acquiring unit 203, a charge amount determining unit 204 determines whether the first battery 110 is in a fully charged state or whether the charge amount of the first battery 110 is insufficient. For example, when an inter-terminal voltage of the first battery 110 is equal to or more than a first threshold, the charge amount determining unit 204 determines that the first battery 110 is in a fully charged state. When the inter-terminal voltage of the first battery 110 is less than the first threshold, the charge amount determining unit 204 determines that the first battery 110 is not in a fully charged state. When the inter-terminal voltage of the first battery 110 is equal to or more than a second threshold, the charge amount determining unit 204 determines that a charge amount of the first battery 110 is not insufficient. Note that the first threshold is larger than the second threshold.

When the inter-terminal voltage of the first battery 110 is less than the second threshold, the charge amount determining unit 204 determines that the charge amount of the first battery 110 is insufficient. On the basis of the charge amount of the second battery 130 acquired by the charge amount acquiring unit 203, the charge amount determining unit 204 determines whether the second battery 130 is in a fully charged state or whether the charge amount of the second battery 130 is insufficient. For example, when an inter-terminal voltage of the second battery 130 is equal to or more than a third threshold, the charge amount determining unit 204 determines that the second battery 130 is in a fully charged state. When the inter-terminal voltage of the second battery 130 is less than the third threshold, the charge amount determining unit 204 determines that the second battery 130 is not in a fully charged state. When the inter-terminal voltage of the second battery 130 is equal to or more than a fourth threshold, the charge amount determining unit 204 determines that a charge amount of the second battery 130 is not insufficient. When the inter-terminal voltage of the second battery 130 is less than the fourth threshold, the charge amount determining unit 204 determines that the charge amount of the second battery 130 is insufficient. Note that the third threshold is larger than the fourth threshold.

A charge control unit 205 sets, selects, or switches an operation mode of the bidirectional DC-DC converter 120. The bidirectional DC-DC converter 120 has a mode in which the second battery 130 is charged by the first battery 110 and a mode in which the first battery 110 is charged by the second battery 130. The bidirectional DC-DC converter 120 operates according to an operation mode set by the charge control unit 205.

There is a case where the engine 102 is in operation, the first battery 110 is in a fully charged state, and the second battery 130 is not in a fully charged state. In this case, the charge control unit 205 controls the bidirectional DC-DC converter 120 to charge the second battery 130 with power supplied from the first battery 110. There is a case where the engine 102 is in operation, the first battery 110 is in a fully charged state, and the second battery 130 is in a fully charged state. In this case, the charge control unit 205 controls the bidirectional DC-DC converter 120 so as not to charge the first battery 110 and the second battery 130. There is a case where the engine 102 is in operation and the first battery 110 is not in a fully charged state. In this case, the charge control unit 205 controls the AC-DC converter 104 to charge the first battery 110 with power generated by the generator 103.

There is a case where the engine 102 is stopped, the first battery 110 is insufficiently charged, and the second battery 130 is not insufficiently charged. In this case, the charge control unit 205 controls the bidirectional DC-DC converter 120 to charge the first battery 110 with power supplied from the second battery 130. When the engine 102 is stopped and the first battery 110 is not insufficiently charged, the charge control unit 205 controls the bidirectional DC-DC converter 120 so as not to charge the first battery 110 from the second battery 130.

A load detection unit 206 acquires a load current detected by the inverter 105. An engine control unit 207 adjusts an engine speed according to the load current. In general, when the load current increases, the engine speed increases, and when the load current decreases, the engine speed decreases. The storage device 210 may store a mapping table that converts the load current into the engine speed (throttle opening). The engine control unit 207 may determine a throttle opening corresponding to the load current by referring to the mapping table and apply the determined throttle opening to the engine 102.

Flowchart

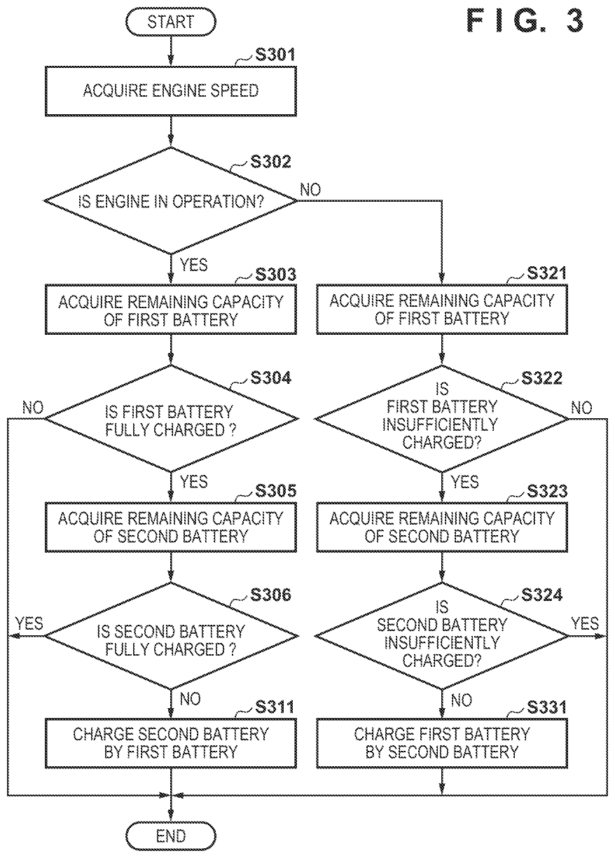

FIG. 3 is a flowchart illustrating a control method. This control method is repeatedly executed at predetermined intervals (for example, 10 milliseconds).

In S301, the CPU 200 (operation state acquiring unit 201) acquires an engine speed which is a parameter correlated with an operation state of the engine 102. Here, as an example, the engine speed is acquired. Information indicating whether the engine 102 is in operation or stopped can be used instead of the engine speed.

In S302, the CPU 200 (operation determining unit 202) determines whether the engine 102 is in operation on the basis of the engine speed. If the engine 102 is in operation, the CPU 200 proceeds to S303. If the engine 102 is not in operation, the CPU 200 proceeds to S321.

(1) In Operation

In S303, the CPU 200 (charge amount acquiring unit 203) acquires a remaining capacity of the first battery 110.

In S304, the CPU 200 (charge amount determining unit 204) determines whether the first battery 110 is fully charged. If the first battery 110 is not fully charged, the CPU 200 ends the control method. In this case, the first battery 110 is continuously charged by power generated by the generator 103. Meanwhile, if the first battery 110 is fully charged, the CPU 200 proceeds to S305.

In S305, the CPU 200 (charge amount acquiring unit 203) acquires a remaining capacity of the second battery 130.

In S306, the CPU 200 (charge amount determining unit 204) determines whether the second battery 130 is fully charged. If the second battery 130 is fully charged, the CPU 200 ends the control method. Meanwhile, if the second battery 130 is not fully charged, the CPU 200 proceeds to S311.

In S311, the CPU 200 (charge control unit 205) controls the bidirectional DC-DC converter 120 to supply power from the first battery 110 to the second battery 130 via the bidirectional DC-DC converter 120, thereby charging the second battery 130.

(2) During Stop

In S321, the CPU 200 (charge amount acquiring unit 203) acquires a remaining capacity of the first battery 110.

In S322, the CPU 200 (charge amount determining unit 204) determines whether the first battery 110 is insufficiently charged. If the first battery 110 is not insufficiently charged, the CPU 200 ends the control method. Meanwhile, if the first battery 110 is insufficiently charged, the CPU 200 proceeds to S323.

In S323, the CPU 200 (charge amount acquiring unit 203) acquires a remaining capacity of the second battery 130.

In S324, the CPU 200 (charge amount determining unit 204) determines whether the second battery 130 is insufficiently charged. If the second battery 130 is insufficiently charged, the CPU 200 ends the control method. Meanwhile, if the second battery 130 is not insufficiently charged, the CPU 200 proceeds to S331.

In S331, the CPU 200 (charge control unit 205) controls the bidirectional DC-DC converter 120 to supply power from the second battery 130 to the first battery 110 via the bidirectional DC-DC converter 120, thereby charging the first battery 110.

### SUMMARY

[Viewpoint 1]

As illustrated in FIG. 1, the AC-DC converter 104 is an example of a first conversion circuit that converts an alternating current generated by the generator 103 into a direct current. The first battery 110 is an example of a first battery to be charged with power output from the first conversion circuit. The inverter 105 is an example of a second conversion circuit that is connected to the first battery, converts power supplied from the first battery, and supplies the converted power to the load 150. The bidirectional DC-DC converter 120 is an example of a third conversion circuit that is connected to the first battery and converts a DC voltage supplied from the first battery into a first charging voltage. The second battery 130 is an example of a second battery that is connected to the third conversion circuit and is charged with the first charging voltage supplied from the third conversion circuit. During an operation period in which the engine is operating, the first conversion circuit (for example, the AC-DC converter 104) may be configured to generate a second charging voltage by converting power generated by the generator, and charge the first battery with the second charging voltage. During a stop period in which the engine is stopped, the third conversion circuit (for example, the bidirectional DC-DC converter 120) is configured to convert a DC voltage supplied from the second battery into a third charging voltage for charging the first battery, and charge the first battery with the third charging voltage. As described above, the engine-driven generator 100 includes the first battery 110 and the second battery 130, and therefore can achieve an increase in battery capacity at relatively low cost. In addition, since the first conversion circuit (AC-DC converter 104) supplies power to the second conversion circuit (inverter 105) via the first battery 110, followability to a change in load is improved. This is because followability of the first battery 110 to a load is better than followability of the engine 102 and the generator 103 to the load.

[Viewpoint 2]

The third conversion circuit may be a bidirectional DC-DC converter. Note that there are various circuit formats of the bidirectional DC-DC converter, but the present embodiment does not depend on a circuit format. Therefore, in the present embodiment, the degree of freedom in selecting a circuit format of the bidirectional DC-DC converter is high.

[Viewpoints 3 and 4]

The third conversion circuit may be configured to charge the second battery by supplying power from the first battery to the second battery when a remaining capacity of the first battery is not insufficient in an operation period. The third conversion circuit may be configured not to supply power from the first battery to the second battery when a remaining capacity of the first battery is insufficient in an operation period. As a result, the second battery is less likely to be overcharged, and a life of the second battery will be extended.

The third conversion circuit may charge the second battery by supplying power from the first battery to the second battery when a remaining capacity of the first battery is not insufficient and a remaining capacity of the second battery is insufficient in an operation period. The third conversion circuit does not have to supply power from the first battery to the second battery when a remaining capacity of the first battery is not insufficient and a remaining capacity of the second battery is not insufficient in an operation period.

[Viewpoints 5 and 6]

The third conversion circuit may charge the first battery by supplying power from the second battery to the first battery when a remaining capacity of the first battery is insufficient in a stop period. The third conversion circuit does not have to supply power from the second battery to the first battery when a remaining capacity of the first battery is not insufficient in a stop period. For example, the third conversion circuit may charge the first battery by supplying power from the second battery to the first battery when a remaining capacity of the first battery is insufficient and a remaining capacity of the second battery is not insufficient in a stop period. The third conversion circuit does not have to supply power from the second battery to the first battery when a remaining capacity of the first battery is insufficient and a remaining capacity of the second battery is insufficient in a stop period. As a result, the first battery is less likely to be overcharged, and a life of the first battery will be extended.

[Viewpoints 7, 8, and 9]

Quick charging performance of the first battery may be higher than quick charging performance of the second battery. This will make it easy to ensure followability to the load. A capacity of the second battery may be larger than a capacity of the first battery. This will make it easy to increase the capacity of the battery inexpensively. The first battery may have a small change in capacity according to a load current, and the second battery may have a large change in capacity according to the load current.

[Viewpoint 10]

The second battery may be a battery that is detachably attached to the engine-driven generator and is replaceable by a user. This will improve user convenience.

[Viewpoint 11]

The controller 101 is an example of a controller that sets, as an operation mode of the third conversion circuit, either a first operation mode in which the second battery is charged by the first battery or a second operation mode in which the first battery is charged by the second battery. As described above, the bidirectional DC-DC converter 120 may switch a charging direction (power supply direction) according to a control signal output from the controller 101.

The invention is not limited to the foregoing embodiments, and various variations/changes are possible within the spirit of the invention.

What is claimed is:

1. An engine-driven generator comprising:
an engine;
a generator configured to be driven by the engine;
a first conversion circuit configured to convert an alternating current generated by the generator into a direct current;
a first battery configured to be charged with power output from the first conversion circuit;
a second conversion circuit connected to the first battery and configured to convert power supplied from the first battery, and to supply the converted power to a load;
a third conversion circuit connected to the first battery and configured to convert a DC voltage supplied from the first battery into a first charging voltage; and
a second battery connected to the third conversion circuit and configured to be charged with the first charging voltage supplied from the third conversion circuit, wherein
the first conversion circuit is configured to convert power generated by the generator to generate a second charging voltage and to charge the first battery with the second charging voltage during an operation period in which the engine is operating, and
the third conversion circuit is configured to convert a DC voltage supplied from the second battery into a third charging voltage for charging the first battery and to charge the first battery with the third charging voltage during a stop period in which the engine is stopped.

2. The engine-driven generator according to claim 1, wherein the third conversion circuit is a bidirectional DC-DC converter.

3. The engine-driven generator according to claim 1, wherein
in the operation period,
the third conversion circuit is further configured to:
charge the second battery by supplying power from the first battery to the second battery when a remaining capacity of the first battery is not insufficient; and
stop supplying power from the first battery to the second battery when the remaining capacity of the first battery is insufficient.

4. The engine-driven generator according to claim 3, wherein
the third conversion circuit is further configured to:
charge the second battery by supplying power from the first battery to the second battery when the remaining capacity of the first battery is not insufficient and a remaining capacity of the second battery is insufficient in the operation period, and
stop supplying power from the first battery to the second battery when the remaining capacity of the first battery is not insufficient and the remaining capacity of the second battery is not insufficient in the operation period.

5. The engine-driven generator according to claim 1, wherein
in the stop period,
the third conversion circuit is further configured to:
charge the first battery by supplying power from the second battery to the first battery when a remaining capacity of the first battery is insufficient, and
stop supplying power from the second battery to the first battery when the remaining capacity of the first battery is not insufficient.

6. The engine-driven generator according to claim 5, wherein
the third conversion circuit is further configured to:
charge the first battery by supplying power from the second battery to the first battery when the remaining capacity of the first battery is insufficient and a remaining capacity of the second battery is not insufficient in the stop period, and
stop supplying power from the second battery to the first battery when the remaining capacity of the first battery is insufficient and the remaining capacity of the second battery is insufficient in the stop period.

7. The engine-driven generator according to claim 1, wherein quick charging performance of the first battery is higher than quick charging performance of the second battery.

8. The engine-driven generator according to claim 1, wherein a capacity of the second battery is larger than a capacity of the first battery.

9. The engine-driven generator according to claim 1, wherein
the first battery has a small change in capacity according to a load current, and
the second battery has a large change in capacity according to the load current.

10. The engine-driven generator according to claim 1, wherein the second battery is a battery that is detachably attached to the engine-driven generator and is replaceable by a user.

11. The engine-driven generator according to claim 1, further comprising a controller configured to set, as an operation mode of the third conversion circuit, either a first operation mode in which the second battery is charged by the first battery or a second operation mode in which the first battery is charged by the second battery.
